(19) United States
(12) Patent Application Publication
(10) Pub. No.: US 2009/0199045 A1
(43) Pub. Date: Aug. 6, 2009

(54) SOFTWARE FAULT MANAGEMENT APPARATUS, TEST MANAGEMENT APPARATUS, FAULT MANAGEMENT METHOD, TEST MANAGEMENT METHOD, AND RECORDING MEDIUM

(75) Inventors: Kiyotaka Kasubuchi, Kyoto (JP); Hiroshi Yamamoto, Kyoto (JP); Kiyotaka Miyai, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 12/360,572

(22) Filed: Jan. 27, 2009

(30) Foreign Application Priority Data
Feb. 1, 2008 (JP) P2008-22598

(51) Int. Cl. G06F 11/07

(52) U.S. Cl. 714/38; 714/E11.029

(57) ABSTRACT

A fault management system is provided with a fault data entry accepting portion for accepting entry of fault data including indicator data for assessing three fault assessment items in four assessment grades, a fault data holding portion for storing the fault data, a fault data prioritizing portion for prioritizing the fault data in the order of addressing faults, a customer profile data entry accepting portion for accepting entry of customer profile data indicative of degrees of requirement by each customer regarding the three assessment items and the importance of customers to the user, and a customer profile data holding portion for storing the customer profile data. The fault data prioritizing portion prioritizes the fault data based on assessment values regarding the three assessment items.

### BACKGROUND OF THE INVENTION

1. Field of the Invention

The present invention relates to a fault management apparatus for managing faults in a software system, and a test management apparatus for managing tests performed for software system development and maintenance.

2. Description of the Background Art

Conventionally, faults, such as those called “defects” and “bugs”, often occur during or after development of a software system. Such faults include those correctable with relatively little effort, and those difficult to correct, for example, because their causes are unidentified. In addition, there are faults that greatly affect customers who use the software system, as well as faults that only affect them slightly. Conventionally, to determine the priority order for addressing such various faults, information (such as values) indicating the severity of faults is included beforehand in fault data (a collection of fault-related information, such as dates of fault occurrence and details of faults). For example, the fault data contains assessment values assigned for fault-by-fault assessment in three degrees (1. fatal, 2. considerable, and 3. slight), so that faults with assessment value “1” have high priorities, and faults with assessment value “3” have low priorities. Note that in the following description, priority assignment to fault data to clarify which fault is to be preferentially addressed is referred to as “prioritization”, and a process for this is referred to as a “prioritizing process”.

Also, there are various known software system development techniques, including “waterfall development”, “prototype development”, and “spiral development”. These various development techniques employ software system development phases, such as “requirement definition”, “design”, “programming”, and “testing”. Of these phases, the testing of a software system is typically performed based on test specifications. The test specifications indicate for each test case a test method and conditions for determining a passing status (success or failure).

In software system development, the aforementioned phases might be repeated. In such a case, test cases created at the beginning of development or as a result of any specification change or suchlike are repeatedly tested. In addition, if any fault occurs, test cases are created to perform a test for confirming whether the fault has been appropriately corrected (herein after, referred to as a “correction confirmation test”) and such test cases are also repeatedly tested. For example, supposing a case where a system is upgraded from version 1 (Ver. 1) to version 2 (Ver. 2), correction confirmation tests, along with regression, scenario, and function tests based on the upgrade, have to be performed in relation to faults found in version 1 and faults having occurred during development of version 2 (see FIG. 35). However, in some cases, “testing all test cases” might be difficult due to limitations on development period, human resources, etc. In such a case, for example, extraction of test cases (from among all test cases) to be tested in the current phase is performed based on previous test results. For example, Japanese Laid-Open Patent Publication No. 2007-102475 discloses an inventive test case extraction apparatus capable of extracting suitable test cases with high efficiency, considering previous test results.

In the case of the above-described conventional configuration where the priority order for addressing faults is determined based on only the assessment values indicating the severity of faults in, for example, three grades, if both a frequently-occurring fault and a rarely-occurring fault have the same assessment value, they are not distinguished when determining the priority order for addressing faults. In addition, for example, concerning post-fault system reactivation, some customers require early recovery, yet some others don't. However, conventionally, the priority order for addressing faults cannot be determined considering such customer requirements. Accordingly, there is some demand to determine the priority order for addressing faults, considering various factors other than the severity of faults, for the purpose of software system development and maintenance. In addition, there is some demand for test case extraction to be performed considering various factors.

### SUMMARY OF THE INVENTION

Therefore, an object of the present invention is to provide a system capable of determining the priority order for addressing various faults in a software system, considering various factors. An other object of the present invention is to provide a system capable of extracting suitable test cases to be currently tested from among prepared test cases, considering various factors.

To achieve the above objects, the present invention has the following features.

One aspect of the present invention is directed to a fault management apparatus for managing faults in software, including:

a fault data entry accepting portion for accepting entry of fault data which is information concerning the faults in software and includes indicator data for assessing a plurality of fault assessment items in a plurality of assessment grades;

a fault data holding portion for storing the fault data accepted by the fault data entry accepting portion; and

a fault data ranking portion for ranking the fault data stored in the fault data holding portion based on fault assessment values each being calculated for each fault data piece based on the indicator data.

According to this configuration, a plurality of (fault) assessment items are provided for fault data which is software fault-related information, so that each of the assessment items can be assessed in a plurality of grades. In addition, the fault management apparatus is provided with the fault data ranking portion for ranking the fault data, and the fault data ranking portion ranks the fault data based on the fault assessment values each being calculated for each fault data piece based on assessment values regarding the plurality of assessment items. Accordingly, the fault data can be ranked considering various factors. Thus, when addressing a plurality of faults, it is possible to derive an efficient priority order (for addressing faults).

In such an apparatus, preferably, the fault data entry accepting portion includes an indicator value entry accepting portion for accepting entry of an indicator value in one of four assessment grades for each of three assessment items as the plurality of fault assessment items, and the fault data ranking portion calculates the fault assessment value for each fault data piece based on the indicator value accepted by the indicator value entry accepting portion.

According to this configuration, four-grade assessment regarding three assessment items is performed per fault. Specifically, FMEA (failure mode and effect analysis) employing a four-point method is adopted for software fault assessment. Thus, it is possible to enter each individual fault data piece with relatively little effort, and it is also possible to effectively prevent any software fault-related trouble.

Preferably, such an apparatus further includes a customer profile data entry accepting portion for accepting entry of customer profile data which is information concerning customers for the software and includes requirement degree data indicative of degrees of requirement by each customer regarding the assessment items, and the fault data ranking portion calculates the fault assessment value based on the requirement degree data accepted by the customer profile data entry accepting portion.

According to this configuration, the fault assessment values for ranking the fault data are calculated based on degrees of requirement by each (software) customer regarding the plurality of assessment items. Thus, it is possible to rank the fault data considering the degrees of requirement by the customer regarding the fault.

In such an apparatus, preferably, the fault data ranking portion calculates for each fault data piece a customer-specific assessment value determined per customer, based on indicator values for the three assessment items and the requirement degree data for each customer, and also calculates the fault assessment value based on the customer-specific assessment value only for any customer associated with the fault data piece.

According to this configuration, in the fault assessment values for a fault the degrees of requirement (regarding the plurality of assessment items) for only the customers associated with the fault are reflected. Thus, it is possible to rank the fault data considering, for example, customers provided with a function having the fault.

In such an apparatus, preferably, the customer profile data entry accepting portion includes a customer rank data entry accepting portion for accepting entry of customer rank data for classifying the customers for the software into a plurality of classes, and the fault data ranking portion calculates the fault assessment value based on the customer rank data accepted by the customer rank data entry accepting portion.

According to this configuration, the fault assessment values for ranking the fault data is calculated based on the customer rank data for classifying software customers into a plurality of classes. Thus, it is possible to rank the fault data considering, for example, the importance of customers to the user.

An other aspect of the present invention is directed to a test management apparatus for managing software tests, including:

a test case holding portion for storing a plurality of test cases to be tested repeatedly;

a fault assessment value acquiring portion for acquiring the fault assessment values each being calculated based on indicator data for fault data stored in the fault data holding portion of the fault management apparatus according to one aspect of the present invention, the fault data being associated with any of the test cases; and

a first test case extracting portion for extracting a test case to be currently tested from among the plurality of test cases stored in the test case holding portion, based on the fault assessment values acquired by the fault assessment value acquiring portion.

According to this configuration, a test case to be currently tested is extracted from among a plurality of test cases based on the fault assessment values each being calculated per fault based on assessment values regarding a plurality of assessment items for the fault. Thus, test cases can be extracted considering various factors related to the fault that is the base for the test cases.

A still another aspect of the present invention is directed to a computer-readable recording medium having recorded thereon a fault management program for causing a fault management apparatus for managing faults in software to perform:

a fault data entry accepting step for accepting entry of fault data which is information concerning the faults in software and includes indicator data for assessing a plurality of fault assessment items in a plurality of assessment grades;

a fault data storing step for storing the fault data accepted in the fault data entry accepting step to a predetermined fault data holding portion; and

a fault data ranking step for ranking the fault data stored in the fault data holding portion based on fault assessment values each being calculated for each fault data piece based on the indicator data.

A still another aspect of the present invention is directed to a computer-readable recording medium having recorded thereon a test management program for causing a test management apparatus for managing software tests to perform:

a fault assessment value acquiring step for acquiring fault assessment values each being calculated based on indicator data for assessing a plurality of fault assessment items in a plurality of assessment grades, the indicator data being included in fault data associated with any of a plurality of test cases to be tested repeatedly which is stored in a predetermined test case holding portion; and

a first test case extracting step for extracting a test case to be currently tested from among the plurality of test cases stored in the test case holding portion, based on the fault assessment values acquired in the fault assessment value acquiring step.

Still another aspect of the present invention is directed to a fault management method for managing faults in software, including:

a fault data entry accepting step for accepting entry of fault data which is information concerning the faults in software and includes indicator data for assessing a plurality of fault assessment items in a plurality of assessment grades;

a fault data storing step for storing the fault data accepted in the fault data entry accepting step to a predetermined fault data holding portion; and

a fault data ranking step for ranking the fault data stored in the fault data holding portion based on fault assessment values each being calculated for each fault data piece based on the indicator data.

Still another aspect of the present invention is directed to a test management method for managing software tests, including:

a fault assessment value acquiring step for acquiring fault assessment values each being calculated based on indicator data for assessing a plurality of fault assessment items in a plurality of assessment grades, the indicator data being included in fault data associated with any of a plurality of test cases to be tested repeatedly which is stored in a predetermined test case holding portion; and

a first test case extracting step for extracting a test case to be currently tested from among the plurality of test cases stored in the test case holding portion, based on the fault assessment values acquired in the fault assessment value acquiring step.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram for explaining FMEA which is the concept upon which the present invention is based.

FIG. 2 is a graph for explaining FMEA which is the concept upon which the present invention is based.

FIG. 3 is an overall configuration diagram of a system according to an embodiment of the present invention.

FIG. 4 is a hardware configuration diagram for achieving a software development management system in the embodiment.

FIG. 5 is a diagram illustrating a variant of the hardware configuration for achieving the software development management system.

FIG. 6 is a block diagram illustrating the configuration of a software development management apparatus in the embodiment.

FIG. 7 is a functional block diagram of the software development management system from functional viewpoints in the embodiment.

FIG. 8 is a diagram illustrating the configuration of a test case extracting portion in the embodiment.

FIG. 9 is a diagram showing a record format of a fault table in the embodiment.

FIG. 10 is a diagram showing a record format of a customer profile table in the embodiment.

FIG. 11 is a diagram showing a record format of a test case table in the embodiment.

FIGS. 12A and 12B are diagrams each showing a variant of the record format of the test case table.

FIG. 13 is a diagram showing a record format of a requirement management table in the embodiment.

FIG. 14 is a diagram showing an example where data is stored in the requirement management table in the embodiment.

FIGS. 15A through 15C are diagrams each showing a variant of the record format of the requirement management table.

FIG. 16 is a diagram illustrating a fault data entry dialog in the embodiment.

FIG. 17 is a diagram for explaining an importance list box of the fault data entry dialog in the embodiment.

FIG. 18 is a diagram illustrating an indicator expository dialog in the embodiment.

FIG. 19 is a diagram illustrating a test case registration dialog in the embodiment.

FIG. 20 is a diagram illustrating a customer profile data entry dialog in the embodiment.

FIG. 21 is a diagram showing an example where data is stored in the fault table in the embodiment.

FIG. 22 is a diagram showing an example where data is stored in the customer profile table in the embodiment.

FIG. 23 is a diagram showing results of calculating (broadly-defined) RI values for each fault data item.

FIG. 24 is a flowchart illustrating the operating procedure for a fault data prioritizing process in the embodiment.

FIG. 25 is a diagram illustrating a test case entry dialog in the embodiment.

FIG. 26 is a flowchart illustrating the operating procedure for a test case extraction process in the embodiment.

FIG. 27 is a diagram illustrating a test case extraction dialog in the embodiment.

FIG. 28 is a diagram illustrating an exemplary temporary table used for test case extraction in the embodiment.

FIG. 29 is a flowchart illustrating a detailed operating procedure for a prioritizing process based on total RI values in the embodiment.

FIG. 30 is a diagram illustrating an exemplary temporary table used for the prioritizing process based on the total RI values in the embodiment.

FIG. 31 is a flowchart illustrating a detailed operating procedure for a prioritizing process based on function-specific importance in the embodiment.

FIG. 32 is a diagram illustrating an exemplary temporary table used for the prioritizing process based on the function-specific importance in the embodiment.

FIG. 33 is a diagram illustrating a record format of a customer profile table in a variant of the embodiment.

FIG. 34 is a diagram illustrating an example where data is stored in the customer profile table in the variant of the embodiment.

FIG. 35 is a diagram for explaining tests for software system development.

### DESCRIPTION OF THE PREFERRED EMBODIMENTS

### 1. Introduction

Before describing an embodiment of the present invention, the basic concept of the present invention will be described. A reliability assessment method called “FMEA (failure mode and effect analysis)” is conventionally known for systematically analyzing potential failures and defects of various products in order to prevent the failures and defects of various products. FMEA employs three factors (indicators): “degree (severity)”, “frequency (occurrence)”, and “potential (detectability)” defined to perform failure mode assessment in view of each factor. Here, the “degree (severity)” is an indicator of the magnitude of effect by a failure. The “frequency (occurrence)” is an indicator of how frequently a failure occurs. The “potential (detectability)” is an indicator of the possibility of finding a failure in advance. In addition, failure modes are classified by forms of fault condition, including, for example, disconnection, short-circuit, damage, abrasion, property degradation. FMEA employs a four-point method for performing assessment with four grades per factor and a ten-point method for performing assessment with ten grades per factor. In general, it is reported that the four-point method requires less assessment time than the ten-point method, and therefore can rapidly address failures. An analysis method by FMEA employing the four-point method will be outlined below.

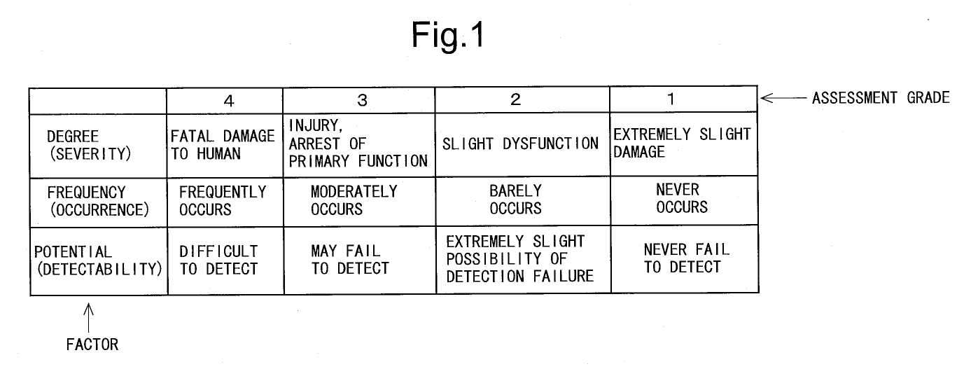

In the case of the FMEA with the four-point method, the meaning of each assessment grade is defined for each factor, for example, as shown in FIG. 1. A value called “Risk Index” (herein after, referred to as an “RI value”) is calculated for each failure mode based on the assessment grade for each of the three factors. Concretely, when the assessment grades for “degree (severity)”, “frequency (occurrence)”, and “potential (detection)” are A, B, and C, respectively, the RI value is calculated by equation (1). Note that the RI value is used as a value for assessing the reliability of an intended product.

RI=\sqrt{A×B×C} (1)

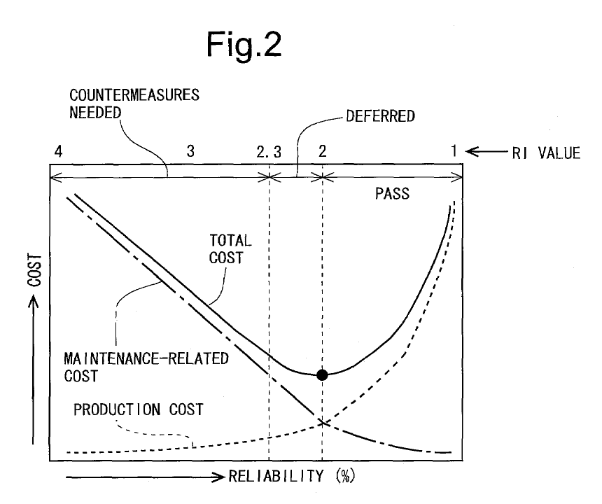

FIG. 2 is a graph showing the relationships of the RI value with respect to the reliability (of a target product) and cost. As the RI value decreases, the reliability of the intended product increases, as shown in FIG. 2. Incidentally, the total cost for production, maintenance, etc., of the target product is generally divided into production cost and maintenance-related cost. When the reliability of the intended product is low (when the RI value is high), the production cost is low, but the maintenance-related cost is high. Accordingly, the total cost is relatively high. This means that when products with low reliability are shipped, failure handling and recovery work is frequently required, resulting in increased total cost. In addition, when the reliability of the intended product is high (when the RI value is low), the maintenance-related cost is low, but the production cost is high. As a result, the total cost is relatively high. This means that when a certain degree of quality or more is required, cost required at production stage becomes extremely high, resulting in increased total cost.

According to FIG. 2, the total cost, which is the sum of the production cost and the maintenance-related cost, is minimized when the RI value is “2”. Moreover, when the reliability corresponds to the RI value at “2.3” or lower, any failure found in the product is considered to be tolerable. On the other hand, when the RI value exceeds “2.3”, the failure is considered to need addressing. Note that when the RI value is less than or equal to “2.0”, the product is considered to be reliable but it might have excessive quality. As such, in the case of FMEA, the most preferable reliability is obtained when the RI value is “2”, and when the RI value exceeds “2.3”, the failure needs to be addressed. Also, FMEA is based on such a concept as “when various failures occur, the failures should be addressed in such a manner as to minimize the total cost, for example, by addressing the failures in the order of priorities applied thereto”.

The embodiment as described below adopts the concept of the above FMEA with the four-point method to mange software system faults. Concretely, three assessment items: “importance”, “priority”, and “probability” are provided as fault management indicators, and four-grade assessment is performed per assessment item. Here, the “importance” is an indicator of the magnitude of an effect by a fault. “Priority” is an indicator of how quickly the recovery from the fault should be brought about. “Probability” is an indicator of how frequently the fault occurs. Fault-related information is stored as fault data, and faults to be corrected are prioritized based on RI values calculated from the fault data.

Hereinafter, the embodiment of the present invention will be described with reference to the accompanying drawings.

### 2. System Configuration

<2.1 System Outline>

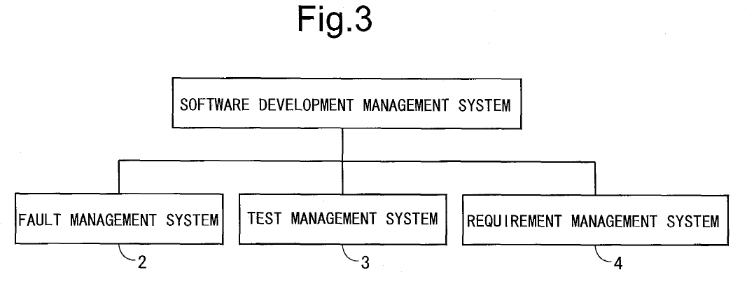

FIG. 3 is an overall configuration diagram of a system according to the embodiment of the present invention. This system is referred to as a “software development management system”, and includes a fault management system 2, a test management system 3, and a requirement management system 4 as subsystems.

<2.2 Hardware Configuration>

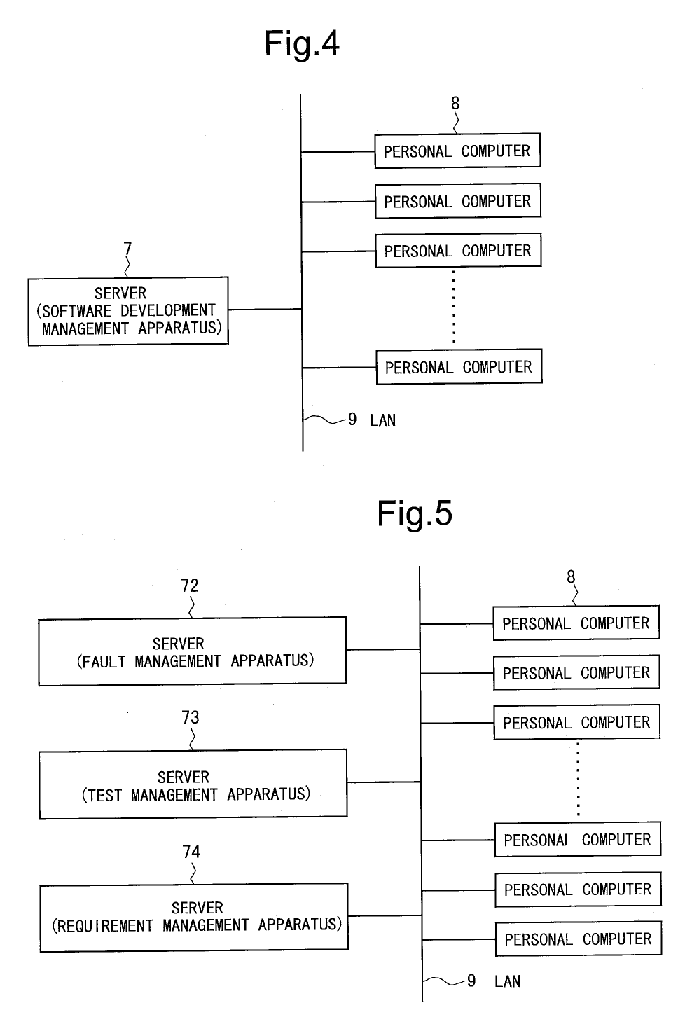

FIG. 4 is a hardware configuration diagram for achieving the software development management system. The system includes a server 7 and a plurality of personal computers 8, and the server 7 and each personal computer 8 are connected to one another via a LAN 9. The server 7 executes processing in response to requests from the personal computers 8, and stores files, databases, etc., which can be commonly referenced from each personal computer 8. In addition, the server 7 manages specifications required for software system development, various tests, and system faults (defects). Accordingly, the server 7 is referred to herein after as the “software development management apparatus”. The personal computer 8 is used to perform tasks such as programming for software system development, enter test cases, execute testing, enter fault data, and so on. Note that the software development management system may be configured as shown in FIG. 5 to include: a server (fault management apparatus) 72 for achieving the fault management system 2; a server (test management apparatus) 73 for achieving the test management system 3; and a server (requirement management apparatus) 74 for achieving the requirement management system 4, i.e., a server may be provided for each subsystem. The present embodiment will be described based on the configuration shown in FIG. 4. The software development management apparatus 7 in the present embodiment includes functions equivalent to the fault management apparatus 72, the test management apparatus 73, and the requirement management apparatus 74 shown in FIG. 5.

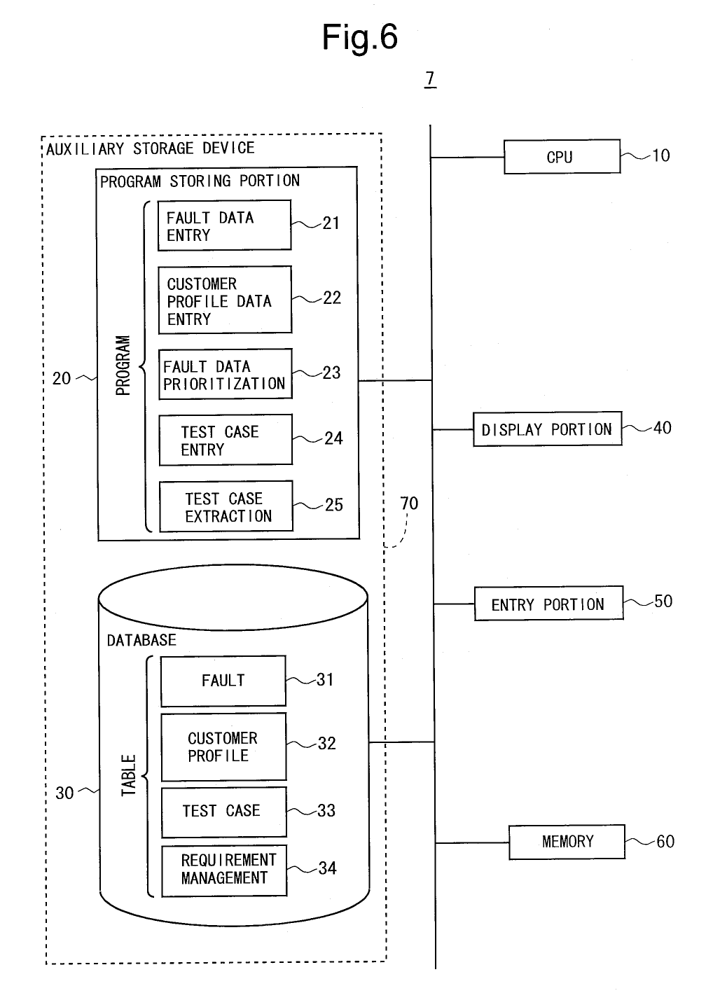

FIG. 6 is a block diagram illustrating the configuration of the software development management apparatus 7. The software development management apparatus 7 includes a CPU 10, a display portion 40, an entry portion 50, a memory 60, and an auxiliary storage device 70. The auxiliary storage device 70 includes a program storage portion 20 and a database 30. The CPU 10 performs arithmetic processing in accordance with given instructions. The program storage portion 20 has stored therein five programs (execution modules) 21 to 25, which are respectively termed “fault data entry”, “customer profile data entry”, “fault data prioritization”, “test case entry”, and “test case extraction”. The database 30 has stored therein four tables 31 to 34, which are respectively termed “fault”, “customer profile”, “test case”, and “requirement management”. The display portion 40 displays, for example, an operating screen for the operator to enter fault data. The entry portion 50 accepts entries from the operator via a mouse and a keyboard. The memory portion 60 temporarily stores data required for the CPU 10 to perform arithmetic processing. Note that the program storage portion 20 may contain any program other than the above five programs, and the database 30 may contain any table other than the above four tables.

The configuration of the personal computer 8 is approximately the same as that of the software development management apparatus (server) 7 shown in FIG. 6, and therefore any description thereof will be omitted herein. However, the personal computer 8 has no database 30 provided in the auxiliary storage device 70.

<2.3 Functional Configuration>

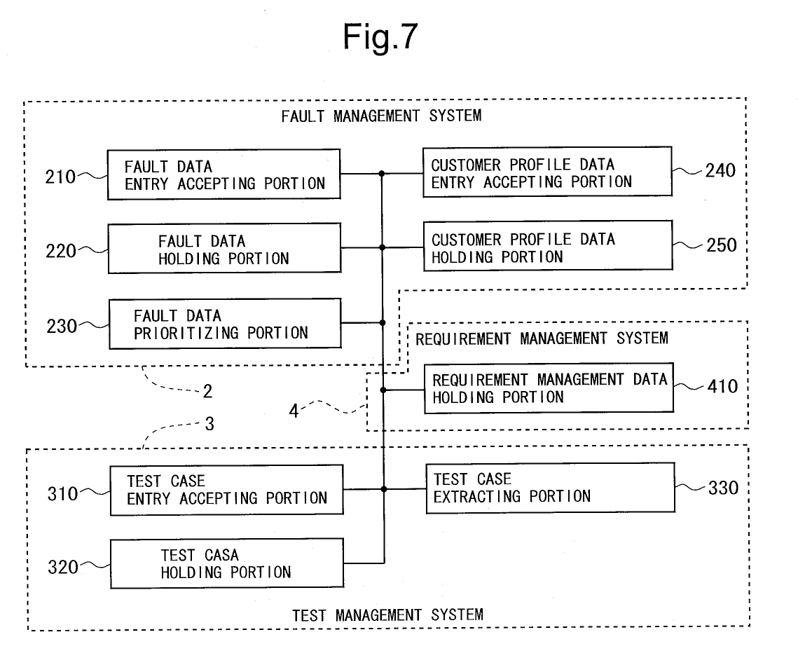

FIG. 7 is a functional block diagram of the software development management system from functional viewpoints. The fault management system 2 includes a fault data entry accepting portion 210, a fault data holding portion 220, a fault data prioritizing portion 230, a customer profile data entry accepting portion 240, and a customer profile data holding portion 250. The fault data entry accepting portion 210 displays an operating screen for the operator to enter fault data, and accepts entries from the operator. The fault data holding portion 220 holds the fault data entered by the operator. The fault data prioritizing portion 230 performs prioritization on the fault data held in the fault data holding portion 220 based on the above-described RI values. The customer profile data entry accepting portion 240 displays an operating screen for the operator to enter customer profile data, and accepts entries from the operator. Note that the customer profile data is information concerning, for example, the intensity of requirement (requirement degree) for fault management indicators on a customer-by-customer basis. The customer profile data holding portion 250 holds the profile data entered by customers.

The following functions are achieved by programs being executed by the CPU 10 utilizing the memory 60. Specifically, the fault data entry accepting portion 210 is achieved by executing the fault data entry program 21. The fault data prioritizing portion 230 is achieved by executing the fault data prioritization program 23. The customer profile data entry accepting portion 240 is achieved by executing the customer profile data entry program 22. In addition, the fault table 31 constitutes the fault data holding portion 220. The customer profile table 32 constitutes the customer profile data holding portion 250.

The test management system 3 includes a test case entry accepting portion 310, a test case holding portion 320, and a test case extracting portion 330. The test case entry accepting portion 310 displays an operating screen for the operator to enter test cases, and accepts entries from the operators. The test case holding portion 320 holds the test cases entered by the operator. The test case extracting portion 330 extracts a test case to be tested in the current phase from among a plurality of test cases based on conditions set by the operator.

The test case entry accepting portion 310 is achieved by executing the test case entry program 24. The test case extracting portion 330 is achieved by executing the test case extraction program 25. In addition, the test case table 33 constitutes the test case holding portion 320.

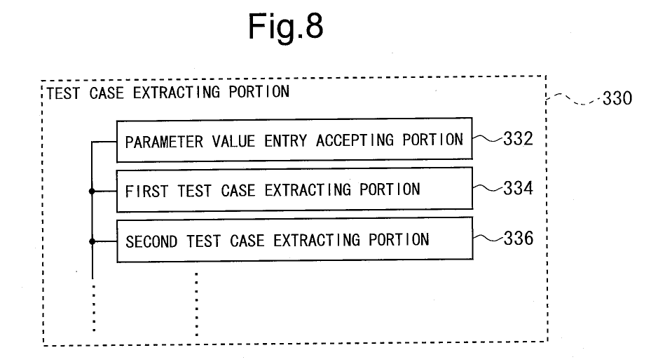

The test case extracting portion 330 at least includes a parameter value entry accepting portion 332, a first test case extracting portion 334, and a second test case extracting portion 336, as shown in FIG. 8. The parameter value entry accepting portion 332 displays an operating screen for the operator to set test case extraction conditions, and accepts entries from the operator. The first test case extracting portion 334 performs prioritization on test case data held in the test case holding portion 320 based on total RI values to be described later. The second test case extracting portion 336 performs prioritization on the test case data held in the test case holding portion 320 based on function-specific importance to be described later.

The requirement management system 4 includes a requirement management data holding portion 410. The requirement management data holding portion 410 holds requirement management data. Note that the requirement management data is data for managing specifications required for a software system (required specifications). The requirement management table 34 constitutes the requirement management data holding portion 410.

Note that the correspondence between the functions and the subsystems is not limited to the configuration shown in FIG. 7.

<2.4 Tables>

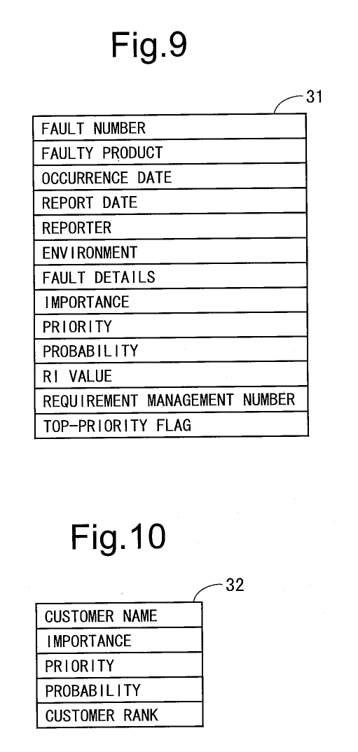

Next, the tables used in the software development management system will be described. FIG. 9 is a diagram showing a record format of the fault table 31. The fault table 31 contains a plurality of items, which are respectively termed “fault number”, “faulty product”, “occurrence date”, “report date”, “reporter”, “environment”, “fault details”, importance”, “priority”, “probability”, “RI value”, “requirement management number”, and “top-priority flag”. Stored in item fields (areas in which to store individual data items) of the fault table 31 are data having contents as described below. Stored in the “fault number” field is a unique number for identifying an individual fault (record). Stored in the “faulty product” field is the name of a product with the fault. Stored in the “occurrence date” field is the date of fault occurrence. Stored in the “report date” field is the date of reporting the fault occurrence. Stored in the “reporter” field is the name of a reporter of the fault occurrence. Stored in the “environment” field is a description of fault occurrence environment (e.g., hardware environment or software environment) Stored in the “fault details” field is a concrete, detailed description of the fault. Stored in the “importance” field is a value indicating the assessment grade for an importance assessment item. Stored in the “priority” field is a value indicating the assessment grade for a priority assessment item. Stored in the “probability” field is a value indicating the assessment grade for a probability assessment item. Stored in the “RI value” field is an RI value calculated based on the values stored in the “importance”, “priority”, and “probability” fields. Stored in the “requirement management number” field is a number for identifying the required specification upon which the fault is based. Note that the “requirement management number” is linked with the item termed “requirement management number” in the requirement management table 34 to be described later. Stored in the “top-priority flag” field is a flag indicating whether or not to preferentially address the fault regardless of the values for the three assessment items.

Note that in the present embodiment, the “importance”, “priority”, and “probability” fields in the fault table 31 constitute indicator data.

FIG. 10 is a diagram showing a record format of the customer profile table 32. The customer profile table 32 contains a plurality of items, which are respectively termed “customer name”, “importance”, “priority”, “probability”, and “customer rank”. Stored in the “customer name” field is the name of a customer using the software system. Stored in the “importance” field is a value indicating the level (assessment grade) required by the customer for the fault assessment item “importance”. Stored in the “priority” field is a value indicating the level (assessment grade) required by the customer for the fault assessment item “priority”. Stored in the “probability” field is a value indicating the level (assessment grade) required by the customer for the fault assessment item “probability”. In the present embodiment, four values from “1” to “4” are prepared to indicate assessment grades. Moreover, as for “importance”, “priority”, and “probability”, the higher the level required by the customer, the lower the value stored in the field. Stored in the “customer rank” field is a value (e.g., a value of “1” to “5”) indicating the importance of the customer to the user (of the software development management system). As for “customer rank”, the more important the customer is to the user, the higher the value stored is.

Note that in the present embodiment, the “importance”, “priority”, and “probability” fields in the customer profile table 32 constitute requirement degree data. In addition, the “customer rank” field in the customer profile table 32 constitutes customer rank data.

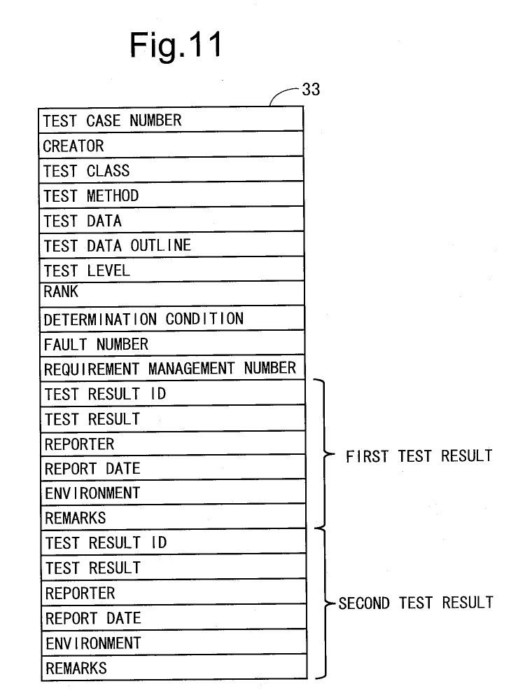

FIG. 11 is a diagram showing a record format of the test case table 33. The test case table 33 contains a plurality of items, which are respectively termed “test case number”, “creator”, “test class”, “test method”, “test data”, “test data outline”, “test level”, “rank”, “determination condition”, “fault number”, “requirement management number”, “test result ID”, “test result”, “reporter”, “report date”, “environment”, and “remarks”. Note that the items “test result ID”, “test result”, “reporter”, “report date”, “environment”, and “remarks” are repeated the same number of times as tests performed for the test case. Data stored in each item field of the test case table 33 is as described below. Stored in the “test case number” field is a unique number for identifying the test case. Stored in the “creator” field is the name of a creator of the test case. Stored in the “test class” field is a class name by which to classify the test case in accordance with a predetermined indicator. Stored in the “test method” field is a description of a method for performing the test. Stored in the “test data” field is a description for specifying data for performing the test (e.g., a full path name). Stored in the “test data outline” field is a description outlining the test data. Stored in the “test level” field is the level of the test case. Examples of the level include “unit test”, “combined test”, and “system test”. Stored in the “rank” field is the importance of the test case. Examples of the importance include “H”, “M”, and “L”. Stored in the “determination condition” field is a description of the criterion for determining the passing status of the test. Stored in the “fault number” field is a number for specifying a fault for which the test case was created. Note that the “fault number” field is linked with the item termed “fault number” in the fault table 31. Stored in the “requirement management number” field is a number for specifying a required specification on which the test case is based. Note that the “requirement management number” is linked with the item termed “requirement management number” in the requirement management table 34 to be described later. Stored in the “test result ID” field is a number for identifying a test result among test cases. Stored in the “test result” field is the result of the test. Examples of the test result include “pass”, “fail”, “deselected”, “unexecuted”, “under test”, and “untestable”. Stored in the “reporter” field is the name of a person who reported the test result. Stored in the “report date” field is the date of reporting the test result. Stored in the “environment” field is a description of the environment of the system or suchlike at the time of the test. Stored in the “remarks” field is a description, such as an annotation, concerning the test.

Note that as for the test result, “pass” means that the test resulted in “pass” (success); “fail” means that the test resulted in “fail” (failure); “deselected” means that no test was performed on the test case (i.e., the test case was not selected for testing in the test phase); “unexecuted” means that the test case is currently queued in the test phase, but has not yet been tested; “under test” means that the test case is currently being tested; and “untestable” means that no test can be performed because the program has not yet been created, for example.

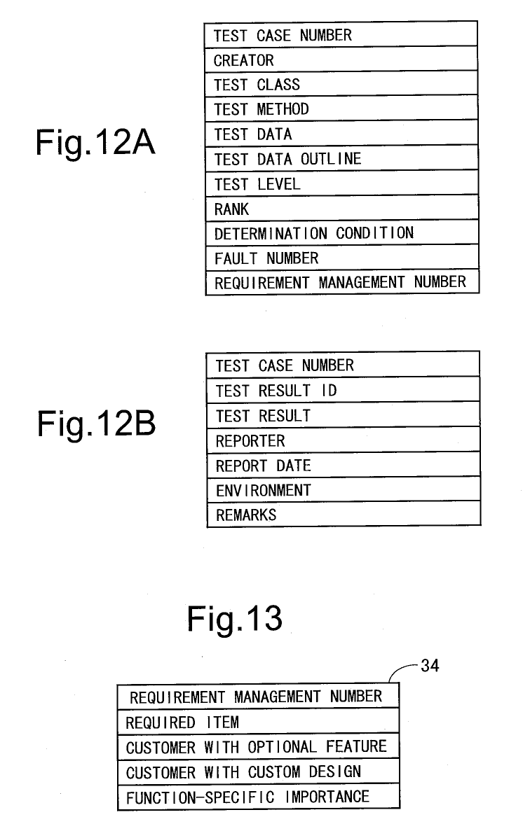

Also, the “test result ID”, “test result”, “reporter”, “report date”, “environment”, and “remarks” fields are repeated in the test case table 33 the same number of times as tests performed. Accordingly, the test case table 33 may be normalized. Specifically, the test case table 33 can be divided into two tables having record formats as shown in FIGS. 12A and 12B.

FIG. 13 is a diagram showing a record format of the requirement management table 34. The requirement management table 34 contains a plurality of items, which are respectively termed “requirement management number”, “required item”, “customer with optional feature”, “customer with custom design”, and “function-specific importance”. Stored in the “requirement management number” field is a unique number for identifying an individual specification required for the software system. Stored in the “required item” field is a type indicating whether the function based on the required specification is incorporated in products for all customers or only in a product for a specific customer. Concretely, the type “standard”, “optional”, or “custom” is stored in the “required item” field. Stored in the “customer with optional feature” field is the name of a customer whose data (record) has the type “optional” stored in the “required item”. Stored in the “customer with custom design” field is the name of a customer whose data (record) has the item “custom” stored in the “required item” field. Stored in the “function-specific importance” field is a value indicating the importance of the function based on the required specification. A detailed description of the function-specific importance will be given later.

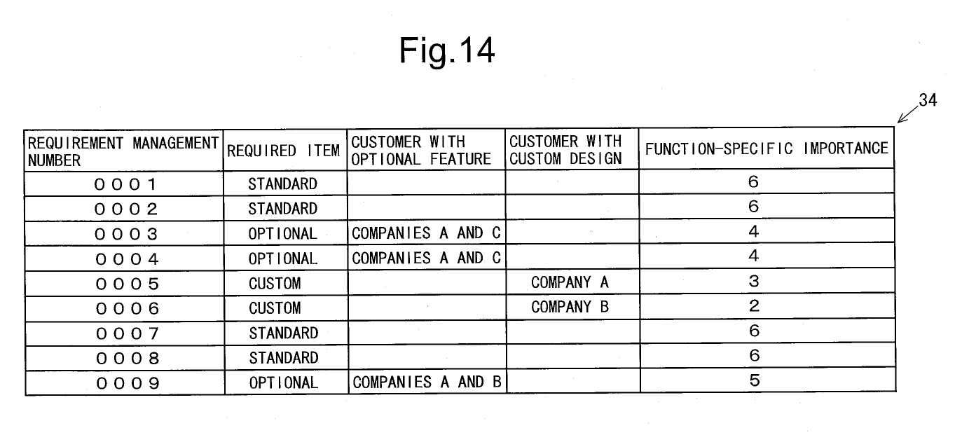

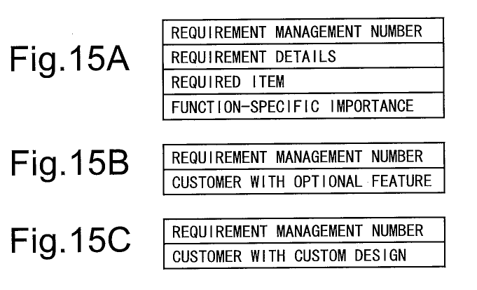

FIG. 14 is a diagram showing an example where data is stored in the requirement management table 34. As shown in FIG. 14, for any record with the “required item” field indicating “optional”, the name of a corresponding customer is stored in the “customer with optional feature” field. Also, for any record with the “required item” field indicating “custom”, the name of a corresponding customer is stored in the “customer with custom design” field. On the other hand, for any record other than those with the “required item” field indicating “optional”, no entry is stored in the “customer with optional feature” field (i.e., a NULL value is set). Also, for any record other than those with the “required item” field indicating “custom”, no entry is stored in the “customer with custom design” field. Accordingly, the requirement management table 34 may be normalized to form three tables having record formats as shown in FIGS. 15A to 15C, for example.

Note that in the present embodiment, the “function-specific importance” field in the requirement management table 34 constitutes required specification rank data.

### 3. Processing in the Fault Management System

Next, processes performed in the fault management system 2 will be described. The processes include a “fault data entry process” for data entry of information concerning an incurred fault, a “customer profile data entry process” for entering the aforementioned customer profile data, and a “fault data prioritizing process” for prioritizing fault data in accordance with the order of addressing faults. Note that the description will be given on the assumption that the operation by the operator for executing each process is performed with the personal computer 8. Accordingly, various dialogs or suchlike to be described later are displayed on the display portion of the personal computer 8.

<3.1 Fault Data Entry Process>

First, the fault data entry process will be described.

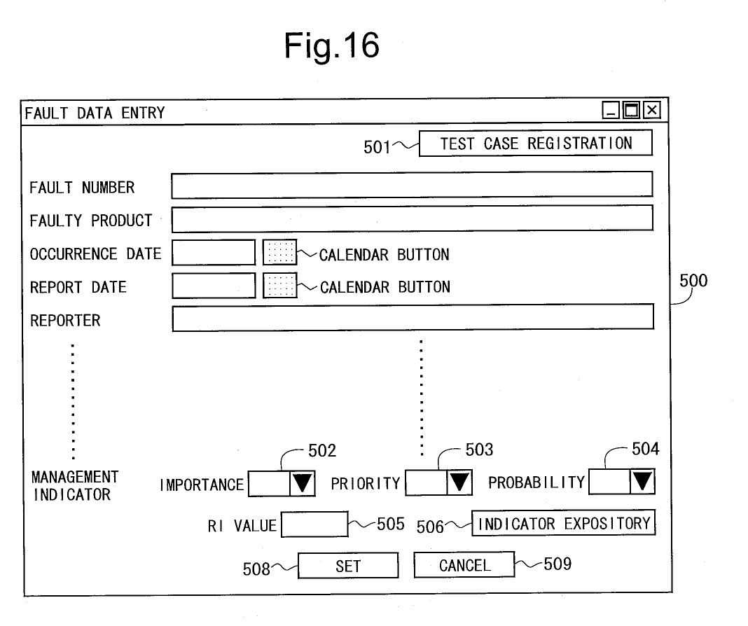

When the operator selects a menu or suchlike for entering fault data, the fault data entry accepting portion 210 displays a fault data entry dialog 500 as shown in FIG. 16. The operator enters information concerning individual fault data items via the fault data entry dialog 500.

The fault data entry dialog 500 includes: text boxes or suchlike for entering fault-related general information (e.g., a text box for entering the “fault number”); an importance list box 502, a priority list box 503, and a probability list box 504 for selecting an assessment grade for each fault assessment item; an RI value display area 505 for displaying an RI value calculated based on the assessment grades of the three assessment items; an “indicator expository” button 506 for displaying an expository screen for each assessment item (an indicator expository dialog 510 to be described later); a “set” button 508 for setting the contents of the entry; and a “cancel” button 509 for canceling the contents of the entry.

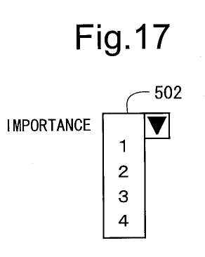

Here, when the operator presses (clicks on) the importance list box 502, the fault data entry accepting portion 210 displays four values that can be selected as importance assessment grades, as shown in FIG. 17. The operator can select any of the values. The same principle applies to the priority list box 503 and the probability list box 504. When any value is selected in each of the importance list box 502, the priority list box 503, and the probability list box 504, an RI value calculated based on the selected values is displayed in the RI value display area 505. The method of calculating the RI value will be described later. Note that in the present embodiment, the importance list box 502, the priority list box 503, and the probability list box 504 constitute an indicator value entry accepting portion.

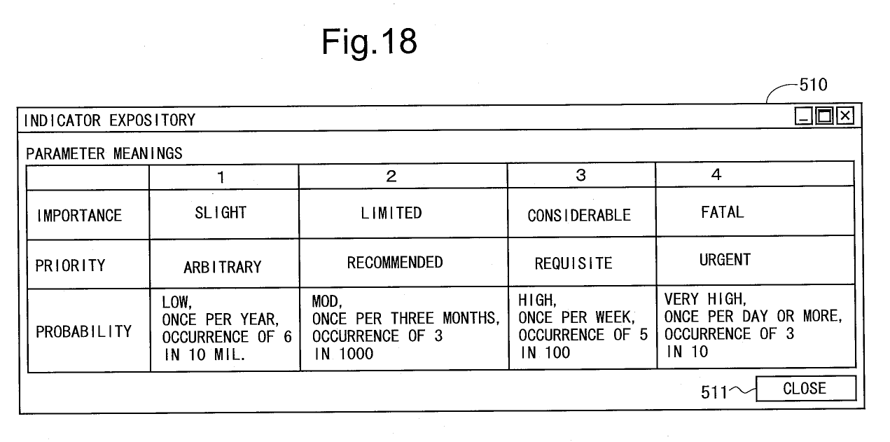

When the operator presses the “indicator expository” button 506, the fault data entry accepting portion 210 displays an indicator expository dialog 510 as shown in FIG. 18. The indicator expository dialog 510 is a dialog for the operator to reference the meaning of each assessment grade for each assessment item. When the operator presses a “close” button 511, the dialog is shut down.

When the operator presses the “set” button 508 in the fault data entry dialog 500, the fault data entry accepting portion 210 imports the contents of the entry by the operator, and adds a single record to the fault table 31 based on the contents of the entry.

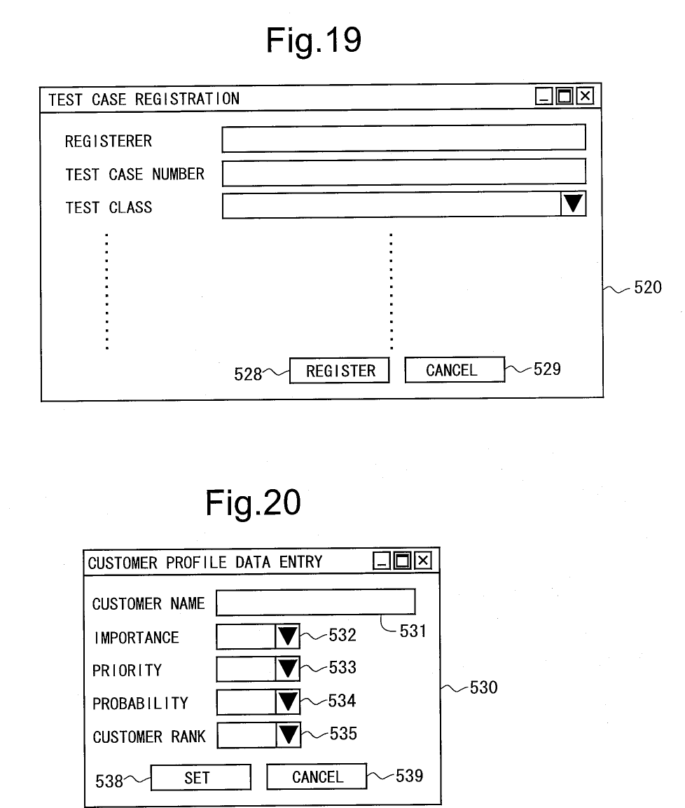

Also, in the present embodiment, the fault data entry dialog 500 is provided with a “test case registration” button 501. The “test case registration” button 501 is available to generate a test case based on fault data. When the operator presses the “test case registration” button 501, a test case registration dialog 520 as shown in FIG. 19 is displayed. The test case registration dialog 520 includes text boxes or suchlike for entering information required for generating a test case based on fault data (e.g., a text box for entering a test case number); a “register” button 528 for executing registration of the test case based on the contents of the entry; and a “cancel” button 529 for canceling the contents of the entry. When the test case is registered via the test case registration dialog 520, test case data is generated based on the contents of the entry via the fault data entry dialog 500 and the contents of the entry via the test case registration dialog 520, and the data is added to the test case table 33 as a single record.

<3.2 Customer Profile Data Entry Process>

Next, the customer profile data entry process will be described. When the operator selects a menu or suchlike for entering customer profile data, the customer profile data entry accepting portion 240 displays a customer profile data entry dialog 530 as shown in FIG. 20. The operator enters customer profile data via the customer profile data entry dialog 530.

The customer profile data entry dialog 530 includes: a customer name entry text box 531 for entering the name of a customer; an importance list box 532 for selecting the value of importance; a priority list box 533 for selecting the value of priority; a probability list box 534 for selecting the value of probability; a customer rank list box 535 for selecting the rank of the customer; a “set” button 538 for setting the contents of entries; and a “cancel” button 539 for canceling the contents of entries. Note that the importance as used herein refers to a value indicating the level (assessment grade) required by the customer for the fault assessment item “importance”. The same principle applies to the priority and the probability. Also, in the present embodiment, the customer rank list box 535 constitutes a customer rank data entry accepting portion.

When the operator presses the “set” button 538 in the customer profile data entry dialog 530, the customer profile data entry accepting portion 240 imports the contents of entries by the operator, and adds a single record to the customer profile table 32 based on the contents of entries.

<3.3 Fault Data Prioritizing Process>

Next, the fault data prioritizing process will be described. In this process, fault data is prioritized in accordance with the order of addressing faults. The fault data prioritization is performed based on an RI value for each fault data item, and at this time, the intensity of requirement (requirement degree) by each customer with respect to each fault assessment item and the importance of the customer to the system user are taken into account. That is, the RI value is calculated not only based on the fault data but also in consideration of the contents of data stored in the customer profile table 32 and the requirement management table 34. Note that the RI value calculated for each customer in consideration of the contents of the customer profile table 32 is referred to as the “customer-specific profile RI value (customer-specific assessment value)”, whereas the RI value used for final prioritization of the fault data considering not only the contents of the customer profile table 32 but also the contents of the requirement management table 34 is referred to as the “total RI value (fault assessment value)”. In the present embodiment, the total RI value rises with the priority.

<3.3.1 Calculation of the RI Value>

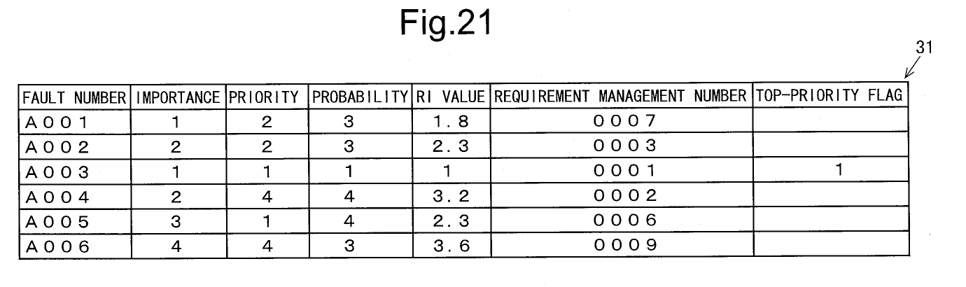

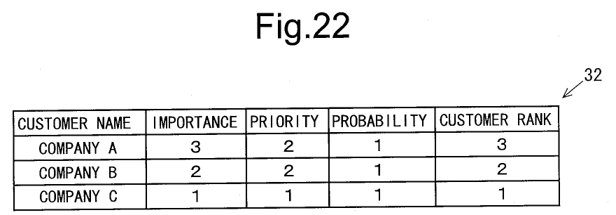

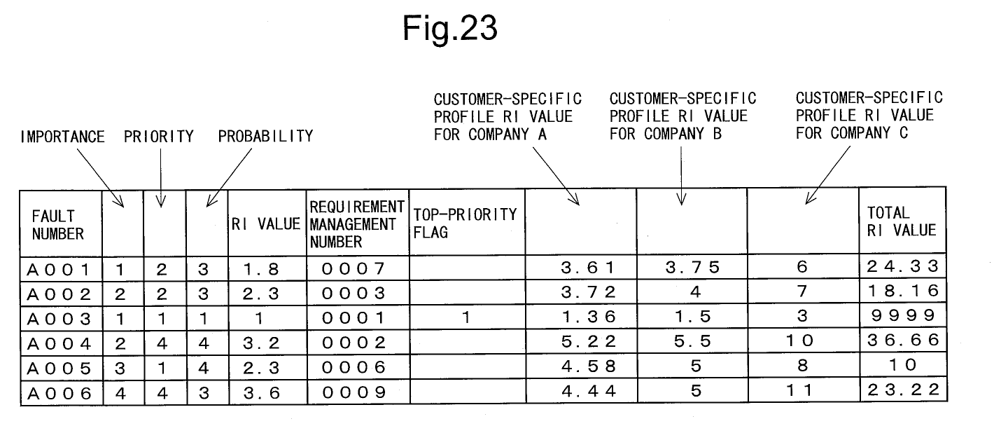

In the present embodiment, the three “(broadly-defined) RI values”, i.e., the “(narrowly-defined RI value”; the “customer-specific profile RI value”, and the “total RI value”, are calculated for each fault data item (i.e., for each record). The calculation method will be described below. Note that the following description will be given on the assumption that data as shown in FIG. 21 is stored in the fault table 31 (only the fields required for description are shown); data as shown in FIG. 22 is stored in the customer profile table 32; and data as shown in FIG. 14 is stored in the requirement management table 34. The results of calculating the (broadly-defined) RI values for each fault data item as will be described below are as shown in FIG. 23. Note that unless otherwise described, the “(narrowly-defined) RI value” is simply referred to below as the “RI value”.

The RI value is the third root of the product of the fault data assessment items “importance”, “priority”, and “probability”. Specifically, when the importance, priority, and probability for fault data are A, B, and C, respectively, an RI value R1 is calculated by equation (2).

R1=\sqrt{A×B×C} (2)

For example, for the fault data with fault number “A001” in FIG. 21, the product of the fault data assessment items is “1×2×3=6”, and the third root of “6” is “1.8” (rounded to one decimal place). Accordingly, the RI value for the fault data with fault number “A001” is “1.8”.

Note that after selecting values in all of the importance list box 502, the priority list box 503, and the probability list box 504 in the fault data entry dialog 500, a value is calculated in a manner as described above, and stored as an RI value to the RI value field of the fault table 31.

The customer-specific profile RI value is the sum of a “value obtained through division of the importance for fault data by the square of the importance for a target customer in the customer profile data”, a “value obtained through division of the priority for the fault data by the square of the priority for the target customer in the customer profile data”, and a “value obtained through division of the probability for the fault data by the square of the probability for the target customer in the customer profile data”. Specifically, if the importance, priority, and probability for the fault data are A, B, and C, respectively, and the importance, priority, and probability for the target customer in the customer profile data are D, E, and F, respectively, then a customer-specific profile RI value R2 is calculated by equation (3).

$$R 2 = \frac{A}{{D}^{2}} + \frac{B}{{E}^{2}} + \frac{C}{{F}^{2}} \qquad ( 3 )$$

For example, as for company A associated with fault data with fault number “A005” in FIG. 21, the customer-specific profile RI value is the sum of the value obtained through division of “3” by the square of “3”, the value obtained through division of “1” by the square of “2”, and the value obtained through division of “4” by the square of “1”, i.e., “4.58” (rounded to two decimal places).

The total RI value is the sum of the “product of the customer-specific profile RI value and the customer rank” for any customer with which a faulty function is provided identified based on the requirement management table 34. Specifically, in the case where companies L, M, and N are the customers provided with the faulty function, when the customer-specific profile RI value and the customer rank are respectively L1 and L2 for company L; M1 and M2 for company M; and N1 and N2 for company N, a total RI value R3 is calculated by equation (4).

R3=L1×L2+M1×M2+N1×N2 (4)

Note that the total RI value for the fault data with top-priority flag “1” is “9999”.

For example, as for the data with fault number “A002” in FIG. 21, the requirement management number is “0003”. Here, for the data with requirement management number “0003” in the requirement management table 34, the “required item” field indicates “optional”, and the “customer with optional feature” field indicates “companies A and C”. Accordingly, it can be appreciated that the faulty function with fault number “A002” is provided to companies A and C. In addition, it can be appreciated from the customer profile table 32 that the customer rank is “3” for company A, and “1” for company C. Furthermore, since the product of the customer-specific profile RI value “3.72” and the customer rank “3” for company A is “11.16”, and the product of the customer-specific profile RI value “7” and the customer rank “1” for company C is “7”, the total RI value is the sum of “11.16” and “7”, i.e., “18.16”.

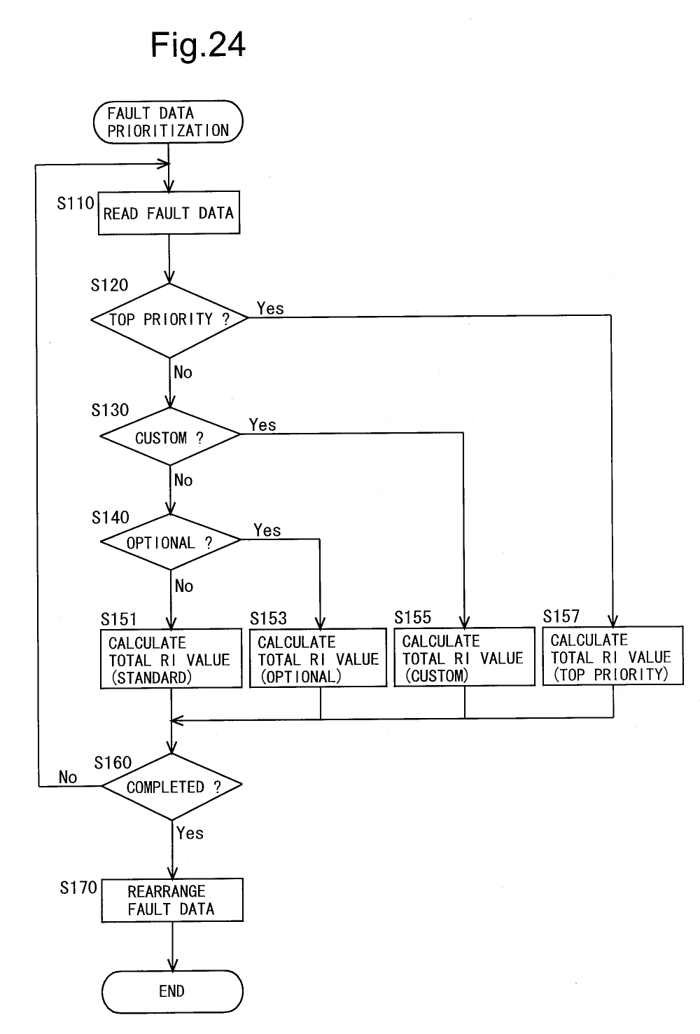

In the present embodiment, the total RI value is calculated as described above during the fault data prioritizing process (see steps S151 to S157 in FIG. 24 to be described later), and the fault data prioritization is performed based on the total RI value.

<3.3.2 Operating Procedure>

FIG. 24 is a flowchart illustrating the operating procedure for the fault data prioritizing process in the present embodiment. When the operator selects a menu or suchlike for the fault data prioritizing process, the fault data prioritizing portion 230 reads fault data for a single record from the fault table 31 within the database 30 (step S110). Thereafter, the fault data prioritizing portion 230 determines whether the top-priority flag for the fault data being read in step S110 is “1” (step S120). If the determination result in step S120 finds that the top-priority flag is “1”, the procedure advances to step S157, or if not, advances to step S130. For example, the top-priority flag for the fault data with fault number “A003” in FIG. 21 is “1”.

In step S130, the fault data prioritizing portion 230 determines whether the fault data being read in step S110 is based on required specifications for “custom”. For example, the requirement management number is “0002” for the fault data with fault number “A004” in FIG. 21, whereas the required item for the data with requirement management number “0002” is indicated as “standard” in the requirement management table 34 shown in FIG. 14. Accordingly, the fault data is not based on required specifications for “custom”. In addition, for example, the requirement management number for the fault data with fault number “A005” in FIG. 21 is “0006”, whereas the required item for the data with requirement management number “0006” is indicated as “custom” in the requirement management table 34 shown in FIG. 14. Accordingly, the fault data is based on the required specifications for “custom”. In this manner, the determination is made as to whether the required item is “custom”, and if the required item is “custom”, the procedure advances to step S155, or if not, advances to step S140.

In step S140, the fault data prioritizing portion 230 determines whether the fault data being read in step S110 is based on required specifications for “optional”. The determination is performed in a manner similar to the above-described determination for “custom”. If the determination result finds that the fault data is based on the required specifications for “optional”, the procedure advances to step S153, or if not, advances to step S151.

In step S151, the fault data prioritizing portion 230 calculates the sum of the “products of the customer-specific profile RI value and the customer rank” for all customers to obtain a total RI value. In step S153, the fault data prioritizing portion 230 calculates the sum of the “products of the customer-specific profile RI value and the customer rank” for customers with their data stored in the “customer with optional feature” field of the requirement management table 34 to obtain a total RI value. In step S155, the fault data prioritizing portion 230 calculates the sum of the “products of the customer-specific profile RI value and the customer rank” for customers with their data stored in the “customer with custom design” field of the requirement management table 34 to obtain a total RI value. In step S157, the fault data prioritizing portion 230 sets a total RI value of “9999”. After the above steps (steps S151 to S157), the procedure advances to step S160.

In step S160, the fault data prioritizing portion 230 determines whether all records for the fault data stored in the fault table 31 have been completely read. If the determination result finds that all records have been completely read, the procedure advances to step S170, or if not, returns to step S110.

In step S170, the fault data prioritizing portion 230 performs fault data prioritization based on the total RI values calculated in steps S151, S153, S155, and S157. At this time, for example, each fault data is assigned a priority in order from highest to lowest value based on the total RI value for the fault data shown in FIG. 23. Then, fault data information is displayed on the personal computer 8 in descending order of the total RI value. Thus, the fault data prioritizing process is completed.

### 4. Processing in the Test Management System

Next, processes to be performed in the test management system 3 will be described. The processes include: a “test case entry process” for data entry of test case information; and a “test case extraction process” for extracting a test case to be tested in the current phase from among a plurality of test cases based on conditions set by the operator. Note that the test management system 3 performs processes for entering test results and so on, but such processes are not particularly related to the contents of the present embodiment, and therefore any descriptions thereof will be omitted herein. In addition, as with the above-described processes in the fault management system 2, the operator operates the personal computer 8 to execute each process.

<4.1 Test Case Entry Process>

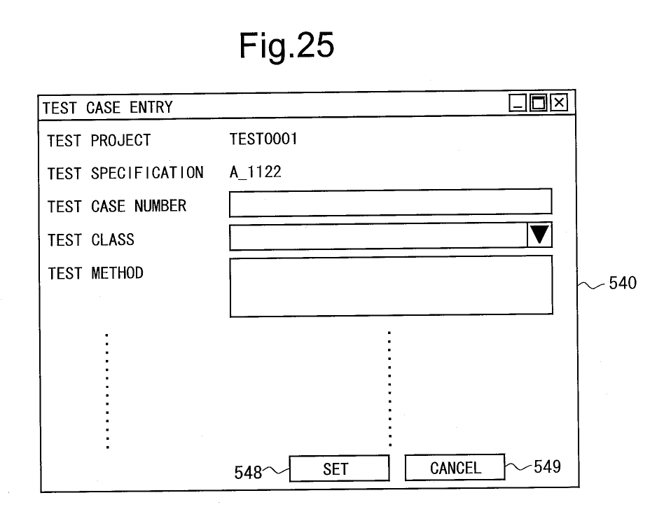

First, the test case entry process will be described. When the operator selects a menu or suchlike for test case entry, the test case entry accepting portion 310 displays a test case entry dialog 540 as shown in FIG. 25. The test case entry dialog 540 includes: a display area for displaying test case-related information (e.g., a display area for displaying the name of a “test project”); text boxes or the like for entering test case-related information (e.g., a text box for entering a “test case number”); a “set” button 548 for setting the contents of entries; and a “cancel” button 549 for canceling the contents of entries. The operator enters details of an individual test case via the test case entry dialog 540.

When the operator presses the “set” button 548 in the test case entry dialog 540, the test case entry accepting portion 310 imports the contents of entries by the operator, and adds a single record to the test case table 33 based on the imported contents of entries.

<4.2 Test Case Extraction Process>

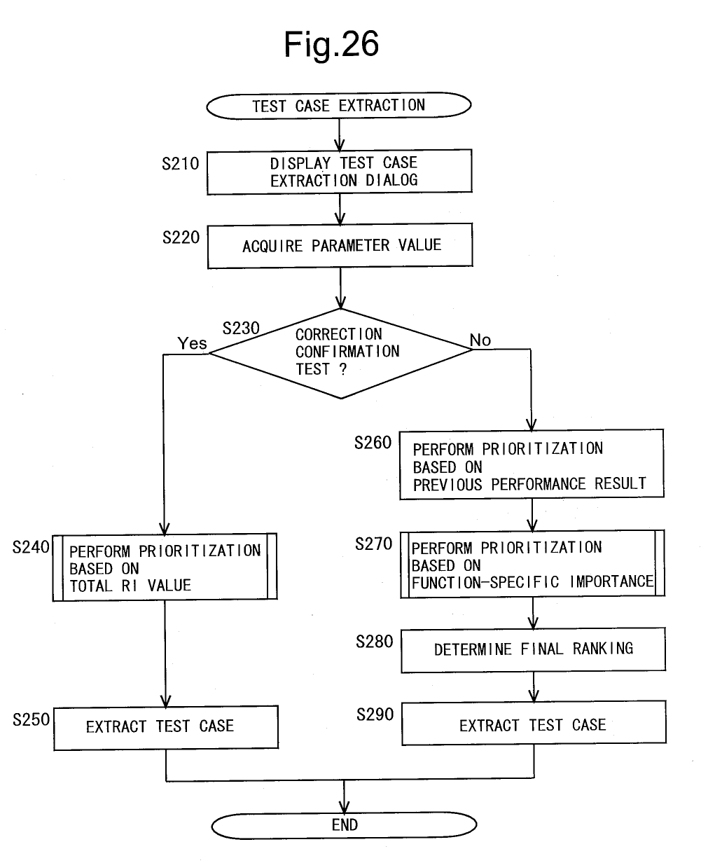

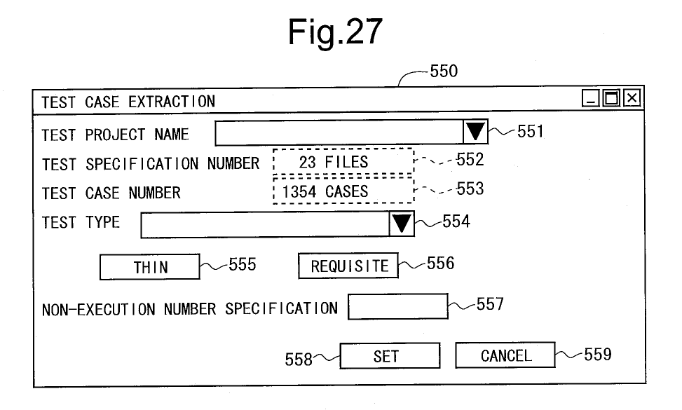

Next, the test case extraction process will be described. FIG. 26 is a flowchart illustrating the operating procedure for the test case extraction process. When the operator selects a menu or suchlike for the test case extraction process, the test case extracting portion 330 displays a test case extraction dialog 550 as shown in FIG. 27 (step S210). The test case extraction dialog 550 includes: a test project name list box 551 for selecting the name of a test project; a test specification number display area 552 for displaying the number of test specifications included in the test project; a test case number display area 553 for displaying the number of test cases included in the test project; a test type list box 554 for selecting the type of a test; a “thin” button 555 for setting detailed conditions for narrowing down the test cases; a “requisite” button 556 for selecting a test case that must be tested; a “non-execution number specification” button 557 for specifying the number of test cases to be extracted; a “set” button 558 for setting the contents of entries; and a “cancel” button 559 for canceling the contents of entries.

When the operator selects an intended test project from the test project name list box 551, the number of test specifications included in the test project is displayed in the test specification number display area 552, and the number of test cases included in the test project is displayed in the test case number display area 553. With the test type list box 554, the type of the test to be currently executed is selected from among some test types such as “correction confirmation test”, “function test”, “regression test”, and “scenario test”. When the operator presses the “thin” button 555, a predetermined dialog is displayed, and the operator sets detailed conditions for narrowing down the test cases via the dialog. When the operator presses the “requisite” button 556, a predetermined dialog is displayed, and the operator sets conditions for the test case that must be tested via the dialog.

Once the operator presses the “set” button 558 in the test case extraction dialog 550, the procedure advances to step S220, and the test case extracting portion 330 acquires various parameter values (values entered by the operator via the test case extraction dialog 550). Thereafter, the procedure advances to step S230, and the test case extracting portion 330 determines whether the test type selected by the operator via the test case extraction dialog 550 is “correction confirmation test” If the determination result finds that the test type is “correction confirmation test”, the procedure advances to step S240, or if not, advances to step S260.

In step S240, the test case extracting portion 330 performs the prioritizing process based on the total RI values for test cases included in the test case table 33 within the database 30. Note that the contents of the process will be described in detail below. After step S240, the procedure advances to step S250.

In step S250, the test case extracting portion 330 extracts test cases in descending order of priority based on the parameter values acquired in step S220. For the test cases extracted in step S250, data “unexecuted” is written into the field for indicating the current test result within the test case table 33. On the other hand, for test cases not extracted in step S250, data “deselected” is written into the field for indicating the current test result within the test case table 33. After step S250, the test case extraction process is completed.

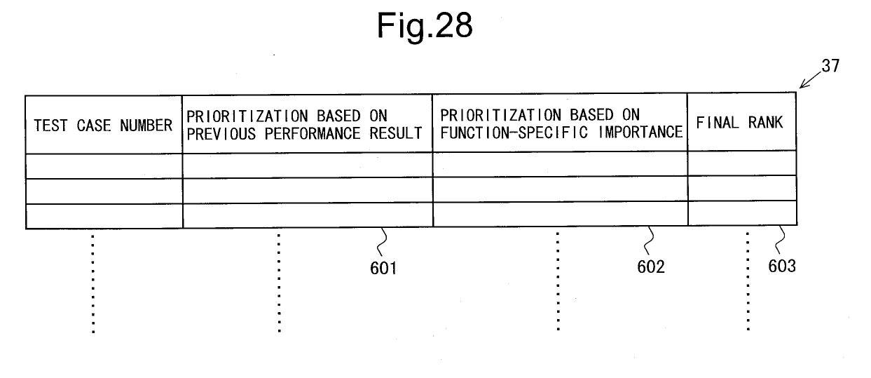

In step S260, the test case extracting portion 330 performs the prioritizing process based on previous (test) performance results for the test cases included in the test case table 33 within the database 30. The test case table 33 contains previous performance results (“pass”, “fail”, “deselected”, “unexecuted”, “under test”, “untestable”) for each test case, and therefore the prioritizing process can be performed based on, for example, the number of “fails”. For example, the priority applied to each test case in step S260 is written into the field denoted by reference numeral “601” within a temporary table 37 as shown in FIG. 28.

After step S260, the procedure advances to step S270, and the test case extracting portion 330 performs the prioritizing process based on function-specific importance of the test cases included in the test case table 33 within the database 30. The priority applied to each test case in step S270 is written into the field denoted by reference numeral “602” in the temporary table shown in FIG. 28. Note that the prioritizing process based on the function-specific importance will be described in detail below. In step S280, the test case extracting portion 330 applies a final priority (final rank) to each test case in accordance with both the priority order based on previous performance results and the priority order based on the function-specific importance. The priority applied to each test case in step S280 is written into the field denoted by reference numeral “603” in the temporary table 37 shown in FIG. 28. After step S280, the procedure advances to step S290.

In step S290, as in step S250, the test case extracting portion 330 extracts test cases in descending order of priority based on the parameter values acquired in step S220. After step S290, the test case extraction process is completed.

Note that in the present embodiment, steps S210 and S220 constitute a parameter value entry accepting portion (step); steps S240 and S250 constitute a first test case extracting portion (step); and steps S260 to S290 constitute a second test case extracting portion (step). In addition, step S240 constitutes a first test case ranking portion (step), and step S250 constitutes a first extraction portion (step).

<4.3 Prioritizing Process Based on the Total RI Value>

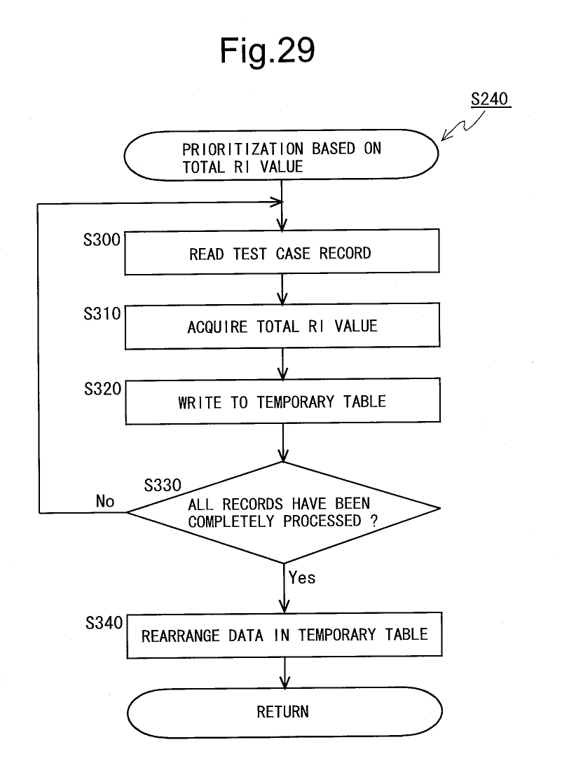

FIG. 29 is a flowchart illustrating a detailed operating procedure for the prioritizing process based on the total RI value. First, a single test case record is read from the test case table 33 within the database 30 (step S300) Thereafter, the total RI value for fault data corresponding to the test case being read in step S300 is acquired (step S310). The test case table 33 has a “fault number” field provided therein, as shown in FIG. 11, and the fault number is stored in the field for any test case created based on the fault data. The total RI value is acquired with reference to the fault table 31 using the fault number as a key.

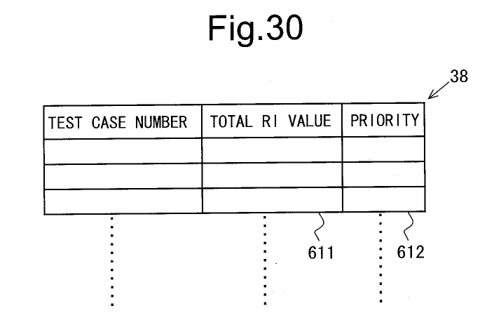

After step S310, the procedure advances to step S320, and the total RI value acquired in step S310 is written into, for example, the field denoted by reference numeral “611” in a temporary table 38 as shown in FIG. 30. After step S320, the procedure advances to step S330, and a determination is made concerning whether all records of test case data stored in the test case table 33 have been completely read. If the determination result finds that all the records have been completely read, the procedure advances to step S340, or if not, returns to step S300.

In step S340, the test case data stored in the temporary table 38 shown in FIG. 30 is sorted (rearranged) in accordance with the total RI value. Then, a priority is applied to each test case based on the sort result. Note that the priority applied to each test case in step S340 is written into the field denoted by reference numeral “612” within the temporary table 38 shown in FIG. 30. After step S340, the procedure advances to step S250 in FIG. 26. Note that when the prioritizing process based on the total RI value is performed, test cases are extracted in step S250 in accordance with their priorities written in the temporary table 38 shown in FIG. 30.

Note that in the present embodiment, step S310 constitutes a fault assessment value acquiring portion (step).

<4.4 Prioritizing Process Based on the Function-Specific Importance>

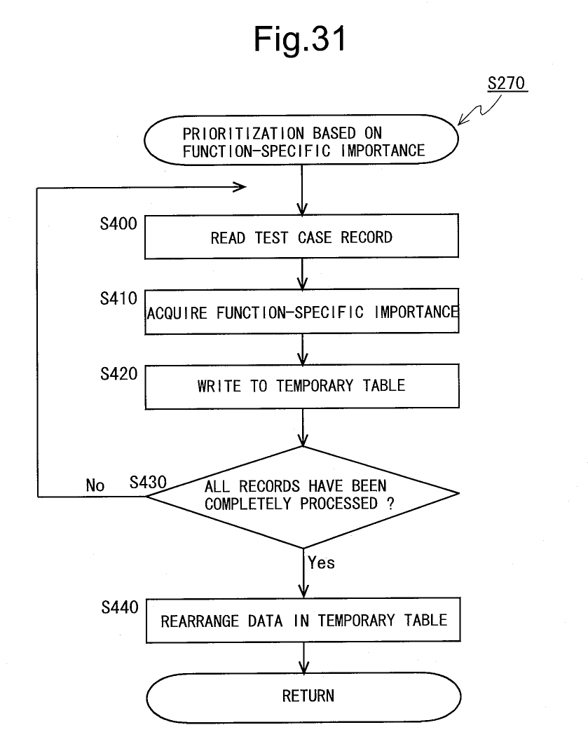

FIG. 31 is a flowchart illustrating a detailed operating procedure for the prioritizing process based on the function-specific importance. First, a single test case record is read from the test case table 33 within the database 30 (step S400). Thereafter, the function-specific importance of the requirement management data corresponding to the test case being read in step S400 is acquired (step S410). The test case table 33 has a “requirement management number” field provided therein as shown in FIG. 11, and the requirement management number, which indicates the required specification upon which the test case is based, is stored in the field. The function-specific importance is acquired with reference to the requirement management table 34 using the requirement management number as a key.

Here, the method for calculating the function-specific importance will be described with reference to FIGS. 14 and 22. In FIG. 14, the required item for the data with requirement management number “0001” is shown as being “standard”. For such data with required item “standard”, the sum of customer ranks of all customers is set to be the function-specific importance. In FIG. 22, the customer ranks for companies A, B, and C are “3”, “2”, and “1”, respectively, and therefore their sum “6” is set to be the function-specific importance. In FIG. 14, the required item for the data with requirement management number “0003” is shown as being “optional”. For such data with required item “optional”, the sum of customer ranks for the customers that are entered in their “customer with optional feature” field is set as the function-specific importance. Companies A and C are indicated under “customer with optional feature” for the data with requirement management number “0003”, and therefore the sum of the customer rank “3” for company A and the customer rank “1” for company C, which is “4”, is set as the function-specific importance. In FIG. 14, the required item for the data with requirement management number “0005” is shown as being “custom”. For such data with the required item “custom”, the customer rank for the customer entered in the “customer with custom design” field is set as the function-specific importance. For the data with requirement management number “0005”, “company A” is indicated under “customer with custom design”, and therefore the customer rank “3” for company A is set as the function-specific importance.

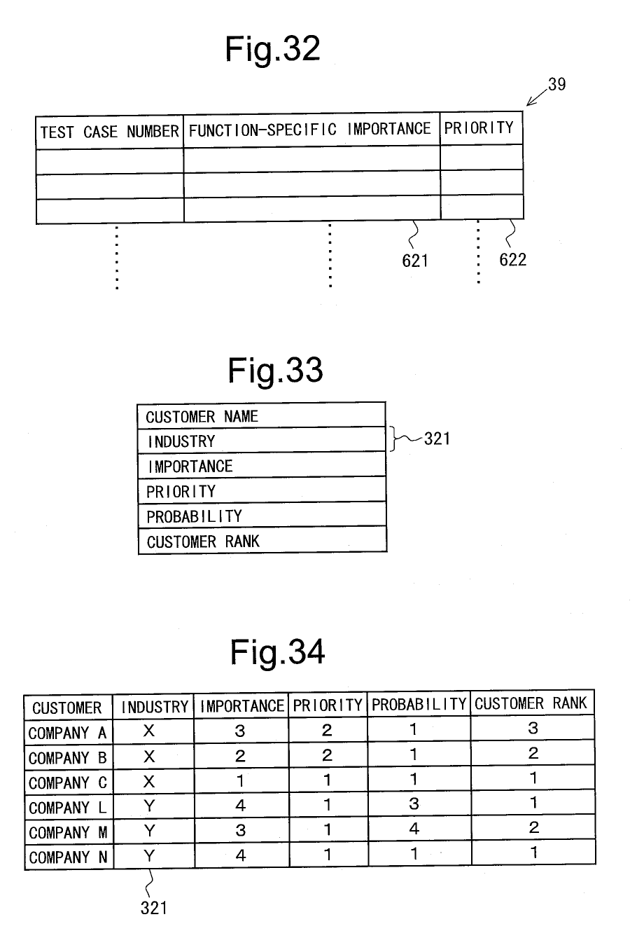

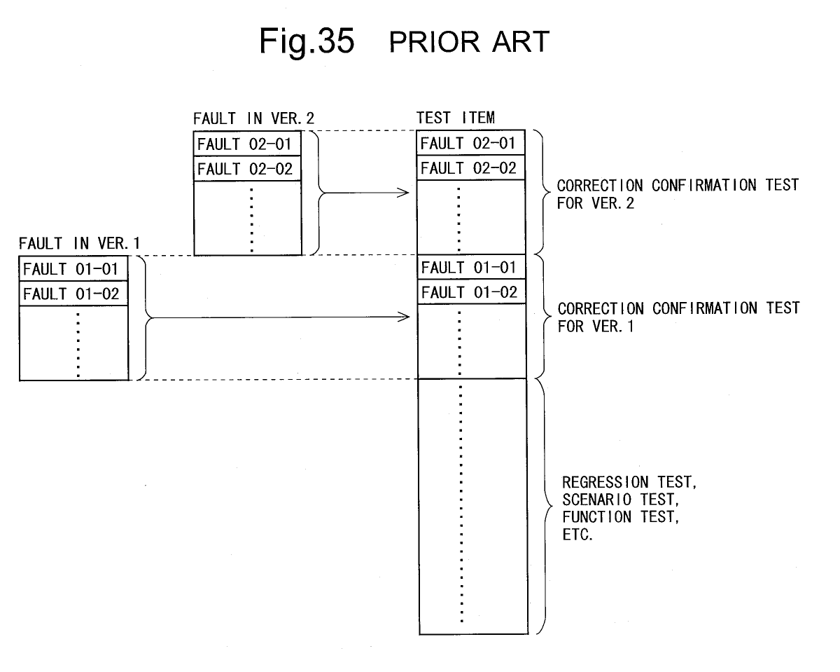

After step S410 in FIG. 31, the procedure advances to step S420, and the function-specific importance acquired in step S410 is written into, for example, the field denoted by reference numeral “621” in a temporary table 39 as shown in FIG. 32. After step S420, the procedure advances to step S430, and a determination is made concerning whether all records for test case data stored in the test case table 33 have been completely read. If the determination result finds that all the records have completely been read, the procedure advances to step S440, or if not, returns to step S400.

In step S440, the test case data stored in the temporary table 39 shown in FIG. 32 is sorted (rearranged) in accordance with the function-specific importance. Then, a priority is applied to each test case based on the sort result. Note that the priority applied to each test case in step S440 is written into the field denoted by reference numeral “622” within the temporary table 39 shown in FIG. 32. After step S440, the procedure advances to step S280 in FIG. 26.

### 5. Effects

According to the software development management system of the present embodiment, three fault assessment items (“importance”, “priority”, and “probability”) are provided for fault data, which is software fault-related information, and assessment is performed for each of the three assessment items in four grades. In addition, the fault data prioritizing portion 230 is provided for fault data prioritization, and the fault data prioritizing portion 230 performs fault data prioritization for each fault data piece based on assessment values for the three assessment items. Therefore, the fault data prioritization can be performed considering various factors as compared to the conventional art in which, for example, three-grade assessment is performed for each item. Thus, the priority order of addressing faults can be determined considering various factors.

In addition, the software development management system is provided with the customer profile data entry accepting portion 240 for accepting entries of data (customer profile data) by the operator indicating per customer the intensity of requirement or suchlike concerning the three assessment items. Furthermore, for each fault data piece, the customer-specific profile RI value is calculated, which is a value obtained by reflecting the intensity of requirement by the customer concerning the value for each assessment item. During the fault data prioritizing process, each customer provided with a faulty function is identified based on the requirement management table 34, and the total RI value is calculated to determine final priorities, based on the customer-specific profile RI values for only the identified customers. Therefore, the fault data prioritization can be performed considering the intensity of fault-related requirement by customers. Thus, it is possible to take countermeasures against faults reflecting requirement by customers, thereby increasing the level of customer satisfaction.

Furthermore, the customer profile data contains customer ranks each being a value indicating the importance of a customer to the user. During the fault data prioritizing process, the total RI value is calculated based on values each obtained through multiplication of the customer-specific profile RI value by the customer rank. Accordingly, the fault data prioritization can be performed considering the importance of customers to the user. Thus, for example, it is possible to preferentially address a fault which a customer important to the user desires to be addressed promptly.

In addition, according to the present embodiment, the software development management system is provided with the test case extracting portion 330 for extracting test cases based on the total RI value for fault data. Accordingly, test case extraction can be performed considering various fault-related factors which are the bases for the test cases. Thus, for example, it is possible to preferentially extract any test case corresponding to a fault having a greater impact.

Furthermore, according to the present embodiment, test cases for a fault correction confirmation test are extracted based on the total RI value for fault data, whereas in the case of any test other than the fault correction confirmation test, test case extraction is performed based on functional importance and previous test results, which are the bases for test cases. Thus, more appropriate test case extraction can be performed in accordance with the type of test to be executed.

### 6. Variant

FIG. 33 is a diagram illustrating the record format of a customer profile table in a variant of the above embodiment, and FIG. 34 is a diagram illustrating an example where data is stored in the table. The requirement by customers concerning each of the above fault assessment items and the importance of customers to the system user may vary in characteristics from industry to industry to which customers belong. Accordingly, the customer profile table can be provided with a field for storing information specifying industries (to which customers belong) as shown in FIG. 33, thereby reflecting industry-specific characteristics in the above-described fault data prioritizing process and test case extraction process. For example, it can be appreciated that in the example shown in FIG. 34, requirement for “probability” is high in industry “X”, whereas requirement for “priority” is high in industry “Y”. By calculating the above-described total RI value considering such industry-specific characteristics, the fault data prioritizing process and the test case extraction process can be performed considering the industry-specific characteristics.

### 7. Others

The above-described software development management apparatus 7 is achieved based on programs 21 to 25 executed by the CPU 10 for creating tables and so on, under the presence of hardware, such as the memory 60 and the auxiliary storage device 70. Part or all of the programs 21 to 25 is provided, for example, via a computer-readable recording medium, such as a CD-ROM, on which the programs 21 to 25 are recorded. The user can purchase a CD-ROM as a recording medium of the programs 21 to 25, and load it into a CD-ROM drive (not shown), so that the programs 21 to 25 can be read from the CD-ROM and installed into the auxiliary storage device 70 of the software development management apparatus. As such, each step shown in the figures, such as FIG. 24, can be provided in the form of a program to be executed by a computer.

While the invention has been described in detail, the foregoing description is in all aspects illustrative and not restrictive. It is understood that numerous other modifications and variations can be devised without departing from the scope of the invention.

Note that the present application claims priority to Japanese Patent Application No. 2008-22598, titled “SOFTWARE FAULT MANAGEMENT APPARATUS, TEST MANAGEMENT APPARATUS, AND PROGRAMS THEREFOR”, filed on Feb. 1, 2008, which is incorporated herein by reference.

What is claimed is:

1. A fault management apparatus for managing faults in software, comprising:
a fault data entry accepting portion for accepting entry of fault data which is information concerning the faults in software and includes indicator data for assessing a plurality of fault assessment items in a plurality of assessment grades;
a fault data holding portion for storing the fault data accepted by the fault data entry accepting portion; and
a fault data ranking portion for ranking the fault data stored in the fault data holding portion based on fault assessment values each being calculated for each fault data piece based on the indicator data.

2. The fault management apparatus according to claim 1,
wherein the fault data entry accepting portion includes an indicator value entry accepting portion for accepting entry of an indicator value in one of four assessment grades for each of three assessment items as the plurality of fault assessment items, and
wherein the fault data ranking portion calculates the fault assessment value for each fault data piece based on the indicator value accepted by the indicator value entry accepting portion.

3. The fault management apparatus according to claim 2, further comprising a customer profile data entry accepting portion for accepting entry of customer profile data which is information concerning customers for the software and includes requirement degree data indicative of degrees of requirement by each customer regarding the assessment items, wherein the fault data ranking portion calculates the fault assessment value based on the requirement degree data accepted by the customer profile data entry accepting portion.

4. The fault management apparatus according to claim 3, wherein the fault data ranking portion calculates for each fault data piece a customer-specific assessment value determined per customer, based on indicator values for the three assessment items and the requirement degree data for each customer, and also calculates the fault assessment value based on the customer-specific assessment value only for any customer associated with the fault data piece.

5. The fault management apparatus according to claim 3,
wherein the customer profile data entry accepting portion includes a customer rank data entry accepting portion for accepting entry of customer rank data for classifying the customers for the software into a plurality of classes, and
wherein the fault data ranking portion calculates the fault assessment value based on the customer rank data accepted by the customer rank data entry accepting portion.

6. A test management apparatus for managing software tests, comprising:
a test case holding portion for storing a plurality of test cases to be tested repeatedly;
a fault assessment value acquiring portion for acquiring the fault assessment values each being calculated based on indicator data for fault data stored in the fault data holding portion of the fault management apparatus of claim 1, the fault data being associated with any of the test cases; and
a first test case extracting portion for extracting a test case to be currently tested from among the plurality of test cases stored in the test case holding portion, based on the fault assessment values acquired by the fault assessment value acquiring portion.

7. The test management apparatus according to claim 6, further comprising a parameter value entry accepting portion for accepting entry of parameter values for setting conditions for test case extraction, wherein the first test case extracting portion includes:
a first test case ranking portion for ranking each test case stored in the test case holding portion based on the fault assessment value for fault data associated with the test case; and
a first extraction portion for extracting a test case to be currently tested, based on the parameter value accepted by the parameter value entry accepting portion and the ranking result by the first test case ranking portion.

8. The test management apparatus according to claim 7, further comprising a second test case extracting portion for extracting a test case to be currently tested from among the plurality of test cases stored in the test case holding portion, based on required specification rank data for classifying required specifications into a plurality of classes, the required specification rank data being included in requirement management data which is information concerning software-required specifications and is stored in a predetermined requirement management data holding portion in association with any of the plurality of test cases, wherein test case extraction is performed by either the first or second test case extracting portion in accordance with the parameter value accepted by the parameter value entry accepting portion.

9. A computer-readable recording medium having recorded thereon a fault management program for causing a fault management apparatus for managing faults in software to perform:
a fault data entry accepting step for accepting entry of fault data which is information concerning the faults in software and includes indicator data for assessing a plurality of fault assessment items in a plurality of assessment grades;
a fault data storing step for storing the fault data accepted in the fault data entry accepting step to a predetermined fault data holding portion; and
a fault data ranking step for ranking the fault data stored in the fault data holding portion based on fault assessment values each being calculated for each fault data piece based on the indicator data.

10. The computer-readable recording medium according to claim 9,
wherein in the fault data entry accepting step, entry of an indicator value in one of four assessment grades is accepted for each of three assessment items as the plurality of fault assessment items, and
wherein in the fault data ranking step, the fault assessment value is calculated for each fault data piece based on the indicator value for the three assessment items accepted in the fault data entry accepting step.

11. The computer-readable recording medium according to claim 10, further comprising a customer profile data entry accepting step for accepting entry of customer profile data which is information concerning customers for the software and includes requirement degree data indicative of degrees of requirement by each customer regarding the assessment items, wherein in the fault data ranking step, the fault assessment value is calculated based on the requirement degree data accepted in the customer profile data entry accepting step.

12. The computer-readable recording medium according to claim 11, wherein in the fault data ranking step, a customer-specific assessment value determined per customer is calculated for each fault data piece based on indicator values for the three assessment items and the requirement degree data for each customer, and the fault assessment value is calculated based on the customer-specific assessment value only for any customer associated with the fault data piece.

13. The computer-readable recording medium according to claim 11,
wherein in the customer profile data entry accepting step, entry of customer rank data for classifying the customers for the software into a plurality of classes is accepted, and
wherein in the fault data ranking step, the fault assessment value is calculated based on the customer rank data accepted in the customer profile data entry accepting step.

14. A computer-readable recording medium having recorded thereon a test management program for causing a test management apparatus for managing software tests to perform:
a fault assessment value acquiring step for acquiring fault assessment values each being calculated based on indicator data for assessing a plurality of fault assessment items in a plurality of assessment grades, the indicator data being included in fault data associated with any of a plurality of test cases to be tested repeatedly which is stored in a predetermined test case holding portion; and
a first test case extracting step for extracting a test case to be currently tested from among the plurality of test cases stored in the test case holding portion, based on the fault assessment values acquired in the fault assessment value acquiring step.

15. The computer-readable recording medium according to claim 14, further comprising a parameter value entry accepting step for accepting entry of parameter values for setting conditions for test case extraction, wherein the first test case extracting step includes:
a first test case ranking step for ranking each test case stored in the test case holding portion based on the fault assessment value for fault data associated with the test case; and
a first extraction step for extracting a test case to be currently tested, based on the parameter value accepted in the parameter value entry accepting step and the ranking result in the first test case ranking step.

16. The computer-readable recording medium according to claim 15, further comprising a second test case extracting step for extracting a test case to be currently tested from among the plurality of test cases stored in the test case holding portion, based on required specification rank data for classifying required specifications into a plurality of classes, the required specification rank data being included in requirement management data which is information concerning software-required specifications and is stored in a predetermined requirement management data holding portion in association with any of the plurality of test cases, wherein test case extraction is performed in either the first or second test case extracting step in accordance with the parameter value accepted in the parameter value entry accepting step.

17. A fault management method for managing faults in software, comprising:
a fault data entry accepting step for accepting entry of fault data which is information concerning the faults in software and includes indicator data for assessing a plurality of fault assessment items in a plurality of assessment grades;
a fault data storing step for storing the fault data accepted in the fault data entry accepting step to a predetermined fault data holding portion; and
a fault data ranking step for ranking the fault data stored in the fault data holding portion based on fault assessment values each being calculated for each fault data piece based on the indicator data.

18. The fault management method according to claim 17,
wherein in the fault data entry accepting step, entry of an indicator value in one of four assessment grades is accepted for each of three assessment items as the plurality of fault assessment items, and
wherein in the fault data ranking step, the fault assessment value is calculated for each fault data piece based on the indicator value for the three assessment items accepted in the fault data entry accepting step.

19. The fault management method according to claim 18, further comprising a customer profile data entry accepting step for accepting entry of customer profile data which is information concerning customers for the software and includes requirement degree data indicative of degrees of requirement by each customer regarding the assessment items, wherein in the fault data ranking step, the fault assessment value is calculated based on the requirement degree data accepted in the customer profile data entry accepting step.

20. The fault management method according to claim 19, wherein in the fault data ranking step, a customer-specific assessment value determined per customer is calculated for each fault data piece based on indicator values for the three assessment items and the requirement degree data for each customer, and the fault assessment value is calculated based on the customer-specific assessment value only for any customer associated with the fault data piece.

21. The fault management method according to claim 19,
wherein in the customer profile data entry accepting step, entry of customer rank data for classifying the customers for the software into a plurality of classes is accepted, and
wherein in the fault data ranking step, the fault assessment value is calculated based on the customer rank data accepted in the customer profile data entry accepting step.

22. A test management method for managing software tests, comprising:
a fault assessment value acquiring step for acquiring fault assessment values each being calculated based on indicator data for assessing a plurality of fault assessment items in a plurality of assessment grades, the indicator data being included in fault data associated with any of a plurality of test cases to be tested repeatedly which is stored in a predetermined test case holding portion; and
a first test case extracting step for extracting a test case to be currently tested from among the plurality of test cases stored in the test case holding portion, based on the fault assessment values acquired in the fault assessment value acquiring step.

23. The test management method according to claim 22, further comprising a parameter value entry accepting step for accepting entry of parameter values for setting conditions for test case extraction, wherein the first test case extracting step includes:
a first test case ranking step for ranking each test case stored in the test case holding portion based on the fault assessment value for fault data associated with the test case; and
a first extraction step for extracting a test case to be currently tested, based on the parameter value accepted in the parameter value entry accepting step and the ranking result in the first test case ranking step.

24. The test management method according to claim 23, further comprising a second test case extracting step for extracting a test case to be currently tested from among the plurality of test cases stored in the test case holding portion, based on required specification rank data for classifying required specifications into a plurality of classes, the required specification rank data being included in requirement management data which is information concerning software-required specifications and is stored in a predetermined requirement management data holding portion in association with any of the plurality of test cases, wherein test case extraction is performed in either the first or second test case extracting step in accordance with the parameter value accepted in the parameter value entry accepting step.
